(19) United States
(12) Patent Application Publication
(10) Pub. No.: US 2005/0038949 A1
(43) Pub. Date: Feb. 17, 2005

(54) Apparatus for enabling distributed processing across a plurality of circuit cards

(76) Inventors: Lynn Patterson, Haymarket, VA (US); Joseph Jacob, Sterling, VA (US)

Correspondence Address: ZITO TLP, 26005 RIDGE ROAD, SUITE 203, DAMASCUS, MD, 20872, US

(21) Appl. No.: 10/752,428

(22) Filed: Jan. 6, 2004

Related U.S. Application Data
(60) Provisional application No. 60/438,160, filed on Jan. 6, 2003.

(51) Int. Cl. G06F 13/36

(52) U.S. Cl. 710/315

(57) ABSTRACT

A computer card for data transfer in a network of multiple computer cards that includes a circuit card comprising a PCI bus, a PCI-based mezzanine card that is mounted to the circuit card and connected to the PCI bus for access to processing resources and memory resources of the circuit card, a multi-port fabric switch, and a PCI-to-switch fabric bridge comprising a port connected to the fabric switch. Multiple cards are networked together to form a switched fabric board interconnect system to meet the many demanding requirements of high-availability systems used in the telecom industry and parallel applications in military real-time computers.

### RELATED APPLICATIONS

This application claims the benefit of Provisional Application No. 60/438,160 filed Jan. 6, 2003

### BACKGROUND OF THE INVENTION

The present invention relates to interprocessor and inter-board connection, including the interconnection of a multiple processors in a distributed or shared processing configuration. More specifically, the present invention relates to the interconnection of multiple processors placed on circuit cards in multi-board VME and PCI applications.

Systems, for complex computational tasks, such as radar, sonar and signal processing and signal intelligence often rely upon a number of processors which must be interconnected for tasks such as data communication, memory sharing and distributed processing. Multiple processor boards, such as the CHAMP-AV illustrated in FIG. 8 and the CHAMP-AV II illustrated in FIG. 9, manufactured by DY4 Systems are often used to achieve higher processing capacity. Some applications require the implementation of several multiple processor boards. Often a bus structure with a separate processor for bus traffic control is implemented for interconnection of multiple processors. A traffic managed buss requires a dedicated active backplane for signal transfer and dedicated control resources. Dedicated switches are typically implemented on dedicated switch cards. A managed buss is not fully scalable and the speed of a managed buss will decrease with the addition of resources.

Many Signal Processing problems demand the use of multiple processors to achieve realtime throughput and response times. For applications of this type, it is invariably necessary to share large amounts of data between the processing nodes. The present invention provides a technology solution to this problem with many specific benefits.

### SUMMARY OF THE INVENTION

The present invention relates to the interconnection of multiple processors placed on circuit cards connected by a PCI bus. The present invention places a bridge and switch on a PCI based mezzanine card, PMC, which enables distributed processing by bridging between the PCI buss of the circuit card and a switched network between the mezzanine cards. The bridge and switch of the present invention can be implemented using a Stargen SG1010 StarFabric Switch, the specifications of which are hereby incorporated by reference. The present invention is also a system of switch enabled circuit cards interconnected to allow multiprocessing a resource sharing in a configurable environment. The present invention provides a switched fabric data interconnect on a PMC which allows for a high speed total sustained bandwidth and zero protocol, PCI to PCI transfers converted to packets which automatically route through the fabric.

The PMC is mounted to a card and is connected to the PCI bus of the card for access to the processing resources and memory resources on the card. A second portion of the PMC forms a part of a switched network between multiple PMC's on multiple cards. The PMC acts as a switch in the network and is connected to the other PMC switches through cabling external to the PCI bus. The PMC also includes a bridge which bridges between the PCI connection and the switch portion of the PMC.

The present invention provides a solution for high performance inter-processor and inter-board data connections. The switch fabric as implemented in the present invention, provides performance scalability and high availability for embedded computer systems. The present invention eliminates the requirement of a dedicated backplane and dedicated switch cards. Increasing slot availability, resources and PCI bus bandwidth.

The present invention PMC card provides the user with a flexible, switched fabric board interconnect system that easily scales from a few to many boards. The flexibility of the system includes the underlying packet switching technology, where data is automatically and transparently routed through a fabric network of switches to it's destination. The switched fabric network is a high-speed serial, switched-fabric technology. The system is based on two types of device, a PCI to switch-fabric bridge, and a switch-fabric switch. The network of bridges and switches presents itself to the application as a collection of bridged PCI devices. Memory attached to one node, is made visible in PCI address space to the other nodes in the network. This is an existing architecture in many systems (i.e. cPCI). From a software interface perspective, a group of cards linked through the switched fabric network of the present invention, appears the same as if they were connected to each other through non-transparent PCI to PCI bridges.

The present invention is designed to meet the many demanding requirements of high-availability systems used in the telecom industry, and parallel applications in military real-time computers, such as fault detection and recovery, redundancy, quality of service and low power consumption. The system provides a rich set of these features, combined with a low latency, high throughput data flow capacity.

The PMC card of the present invention is implemented with two switch-fabric devices, a PCI-to-switch-fabric bridge and a six port fabric switch. The bridge provides two ports which are connected to the switch. The remaining four ports of the switch are accessible externally. Systems are constructed by simply interconnecting between ports on the cards involved, as illustrated in FIG. 1.

The links 12 are point to point, full duplex, and operate at a link rate of 2.5 Gbps. Accounting for the overhead of 8B/10B encoding and packet headers, each link is capable of sustained transfer rates of 200 Mbytes/sec, in each direction simultaneously. It is possible to logically bundle two links together to create 400 MB/sec connections between nodes. The fabric will automatically recognize the parallel path and permit two links to behave logically as a single, higher bandwidth connection.

The implementation of the exemplary embodiments of present invention supports multicasting in hardware. Data packets are automatically replicated by the switches (in hardware) as needed and sent to multiple nodes. Applications that need to share common data between many processing nodes can be greatly accelerated. Applying this feature is done by providing for independent routes from the transmitting node to the multiple receiving nodes. Up to 32 different multicast groups can be defined, as illustrated in See FIG. 5, discussed in greater detail below.

The present invention supports “quality of service” features which are beneficial to ensuring correct real-time behavior in a system. In most real-time systems, there is a mix of critical “real-time” data, and non-real time control messages that flow in the system. The present invention provides mechanisms to ensure priority of the former over the latter. This means a developer who has achieved a correctly functioning real-time system, has the option to further exploit the remaining unused bandwidth in that system for non-critical data, without fear of disrupting the realtime design of the system. In existing systems it is common for developers to employ alternate data paths such as the VMEbus or Ethernet to act as secondary low performance data channels, to avoid the risk of mixing both types of traffic one a single system. The present invention eliminates this risk, thus allowing the simplified model of using a unified data transfer system.

### BRIEF DESCRIPTION OF THE DRAWINGS

For a better understanding of the nature of the present invention, reference is had to the following figures and detailed description, wherein like elements are accorded like reference numerals, and wherein:

FIG. 1 is a simplified block diagram of a link switch portion of the present invention.

FIG. 2 is a block diagram illustrating the one embodiment of network topology utilizing the present invention.

FIG. 3 is a block diagram of an embodiment of the present invention wherein the interconnection of two quad processor circuit cards and a single processor circuit card using a bridge and switch for resource sharing is the illustrated implemented embodiment.

FIG. 4 is simplified memory map diagram of an exemplary embodiment of the present invention.

FIG. 5 is a block diagram illustrating a multicast topology of the present invention.

FIG. 6 is diagram of the network topology of five PMC's of the present invention interconnecting the resources of five circuit cards.

FIG. 7 is a functional block diagram illustrating an alternative configuration for a interconnection of alternative multiple processors circuit cards utilizing the present invention.

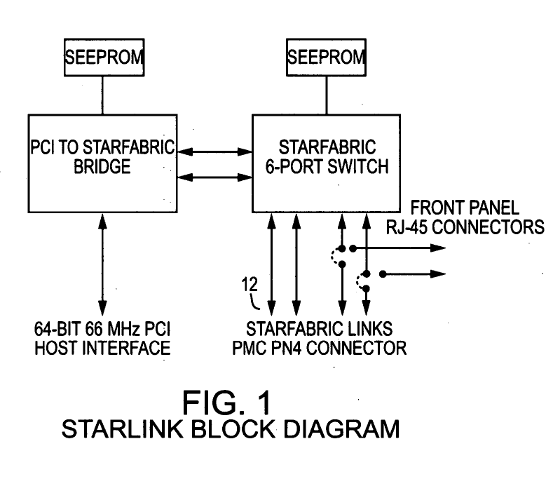

### DETAILED DESCRIPTION OF PREFERRED EXEMPLARY EMBODIMENTS

A system interconnected using the present invention can be configured in many different topologies. The system supports simple point to point connections, basic mesh topologies, and more elaborate topologies with redundant connections for high availability consideration. The system supports routing of packets through up a plurality of switches, so systems can be scaled to extremely large numbers of nodes. A high-availability system can be constructed by providing for redundant routes between end points. A failure in any one connection will be detected and automatically re-routed over the remaining good connection. Failures are reported so that the application software can take appropriate action.

The PMC adaptor provides both the bridge and a switch. A interconnected DSP system is constructed solely of these components, with associated interconnecting wiring or backplane. There are no active backplane overlay modules, active hubs, or special cards required. As a result, the logistics costs of maintenance and sparing are the minimum possible. During a development project, reconfiguring the system requires little more than re-arranging standard category-5 cables and re-initializing the software to perform the network discovery process.

The system of the present invention provides a number of features which permit the construction of high availability systems. The link layer incorporates 8B/10B encoding and CRC checking between nodes, and will re-transmit frames as needed. This checking is done on the fly by the hardware, incurring no performance penalty. Transmission failures are reported to the software layer. It is not necessary to add additional test channel software to monitor the integrity of the network. A system, implemented according to the teachings of the present invention, can be arranged in many different topologies, so as to suit the data flow and redundancy requirements of the system. For high availability systems, it is possible configure a network without any single points of failure. This is done by ensuring that redundant paths exist between nodes in question. During initialization, the fabric will pre-determine alternate routes between nodes, and automatically re-route data to accommodate a failure in wiring, or in a switch.

The physical layer of the exemplary embodiments of the present invention described herein are based on Low Voltage Differential Signaling (LVDS) connections, operating at 622 Mbits/second. Connections are full-duplex, and consist of four pairs in each direction. (16-pins total). Note the natural fit to PMC and VME standards that provide 64-pins of connectivity. (Pn4 and VME P2). The 8B/10B encoded LVDS link layer is well suited to the electrical environment found in a typical embedded computer system. The present invention can be implemented with off the shelf category-5 unshielded cables. The present invention can also be used between cards in a backplane, and also chassis to chassis. This physical layer has many benefits applicable to the design of rugged deployed systems such as:
Use of conventional PWB materials and tracking techniques in backplanes
Use of standard VME and cPCI connectors
No need for coaxial cabling routed to the backplane connectors
No need for expensive co-axial 38999 connectors at the chassis
No extra termination networks
No TTL signal quality issues, with edge rates affected by temperature
Use of standard Category 5 cables for development n

Because of the integration into PCI standards, the present invention can be supported with a VxWorks driver. The applications interaction with the driver is primarily to initialize and configure the various operating modes such as quality of service, shared memory allocation etc. The driver, in conjunction with the hardware performs the entire network discovery process. This includes determining the routing tables which govern how packets flow from source to destination. Once the initialization of the network is complete, processing nodes can transfer data between themselves with conventional memory to memory mechanisms, including, but not limited to DMA transfers. There is no protocol required for data transfers, but one is not restricted from implementing a protocol on top of the shared memory mechanism provided by the implementation of the system of the present invention. Other operating systems can be supported by implementation of the present invention as taught herein.

The PMC of the present invention mounted on a circuit card of the present invention can be configured in different configurations depending upon the intended implementation. Some exemplary configurations include, one with all four ports connecting to the Pn4 connector for backplane I/O usage, another with two ports on the front panel and two ports on the Pn4 connector; A configuration with a rear-panel transition module for VME systems. The module plugs into the P0 and P2 connectors at the rear of the backplane. It provides access to the four fabric ports via RJ-45 connectors, and supports one or two PMC cards installed on the host.

An example application of the present invention is illustrated in FIGS. 2, 3 and 4 and described below. The three diagrams representing the exemplary embodiment system from different perspectives. In FIG. 2, Application Example: Network Topology, a network is constructed from the two fundamental switch components, edge nodes 21 and switches 22. The edge nodes 21 are the termination points for packets crossing the fabric 23. Each PMC of the implementation illustrated uses a switch-fabric-to-PCI bridge 21 that contains two edge nodes EN. The second component illustrated is a fabric switch 22. The processors or DSP's 25 are connected to a PCI bus. The processors 25 of the circuit cards, are illustrated as a node (Node 1 through Node 7) in FIG. 2. The system is comprised of 10 edge nodes EN1-EN10 and 5 switches S1-S5, corresponding to the use of five PMC modules. The network is configured in a mesh topology where each switch has a direct connection to each of the other four switches. This a generic topology, which by virtue of it's symmetry is suited to a random data traffic pattern where each node is sending equally to all the other nodes. For this scenario it can be shown that the fabric has much more capacity than needed to manage the throughput available from the two fabric ports on each PMC.

Take for example the link between S1 and S2. Each edge node sends 1/9 of it's traffic to each other node. (2.5 Gbps/9=0.278 Gbps). The traffic on the link is then:
EN1 to EN3, EN3 to EN1=0.556 Gbps
EN1 to EN4, EN4 to EN1=0.556 Gbps
EN2 to EN3, EN3 to EN2=0.556 Gbps
EN2 to EN4, EN4 to EN2=0.556 Gbps
   Total=2.224 Gbps.
      The link has a 5 Gbps capacity which is more than twice the data traffic load, demonstrating that for the random data distribution case, the fabric has more than sufficient capacity.

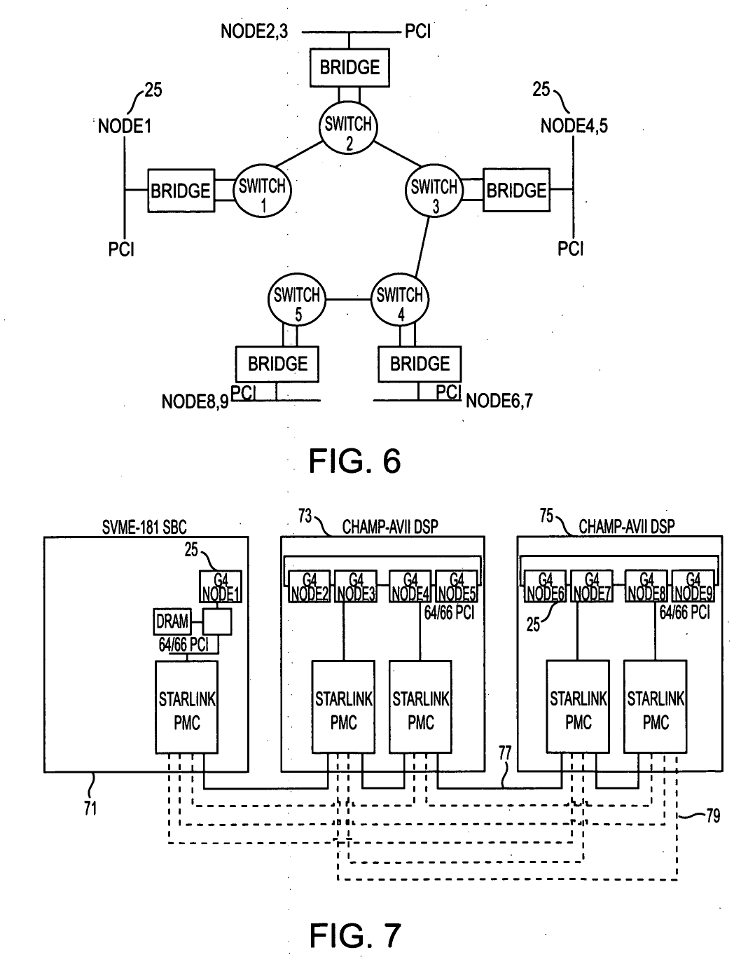

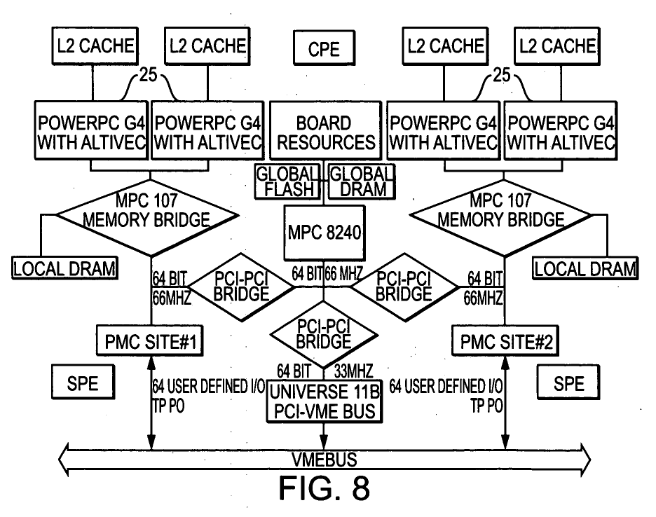

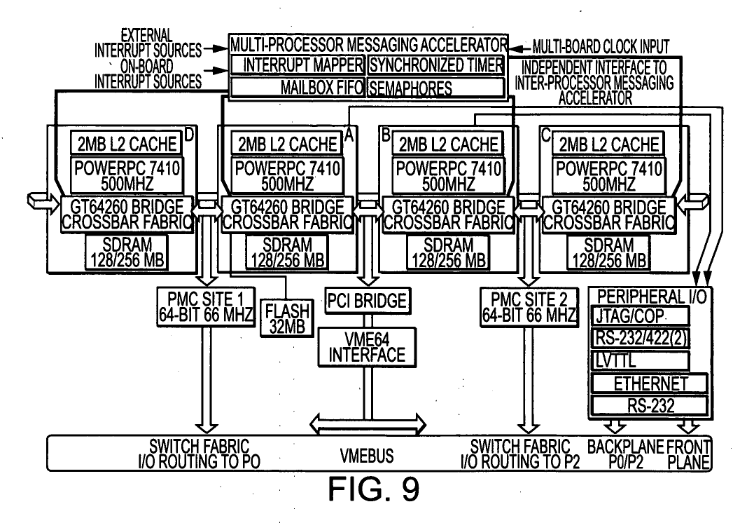

FIG. 6 illustrates an alternative embodiment of the network topology of FIG. 2, where the mesh can be configured as complete or incomplete. The end switches S1 and S5 are connected only to one adjacent switch S2 and S4 respectively. Each fo the intermediate switches is connected to it's two adjacent switches. For example, switch S3 is connected to switch S2 and switch S4. The remaining connection illustrate in the embodiment of FIG. 2 are optional. The additional connections of FIG. 2 allow for redundancy and alternative path configuration. Any one or more of the additional lines can be added to increase capacity and redundancy of the configuration illustrated in FIG. 6.

FIG. 5 represents an example of the implementation of multicast handling in a switch fabric network of the present invention. At 51, EN1 is to send the same frame to EN4, EN6 & EN 8 and one copy of frame is transmitted from EN1 to S1. At 53, switch S1 recognizes frame as multi-cast, it's group requires that the frame is transmitted on ports EN4, EN6 and EN8. At 55, the frame is replicated 3 times. At 57, the frames reach their destination.

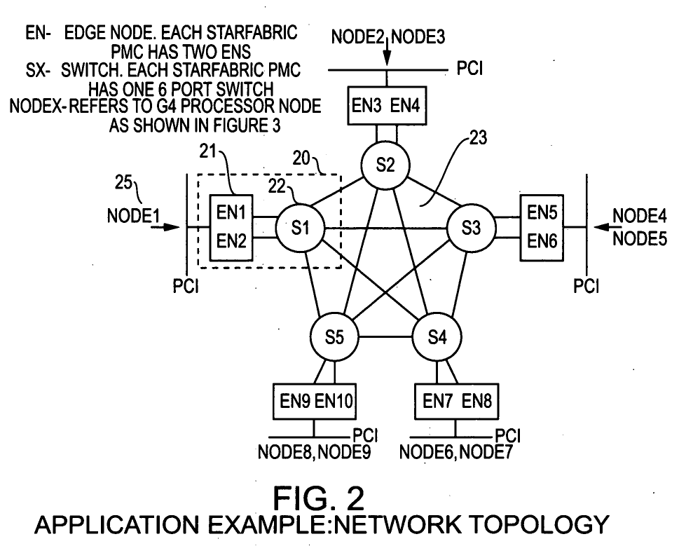

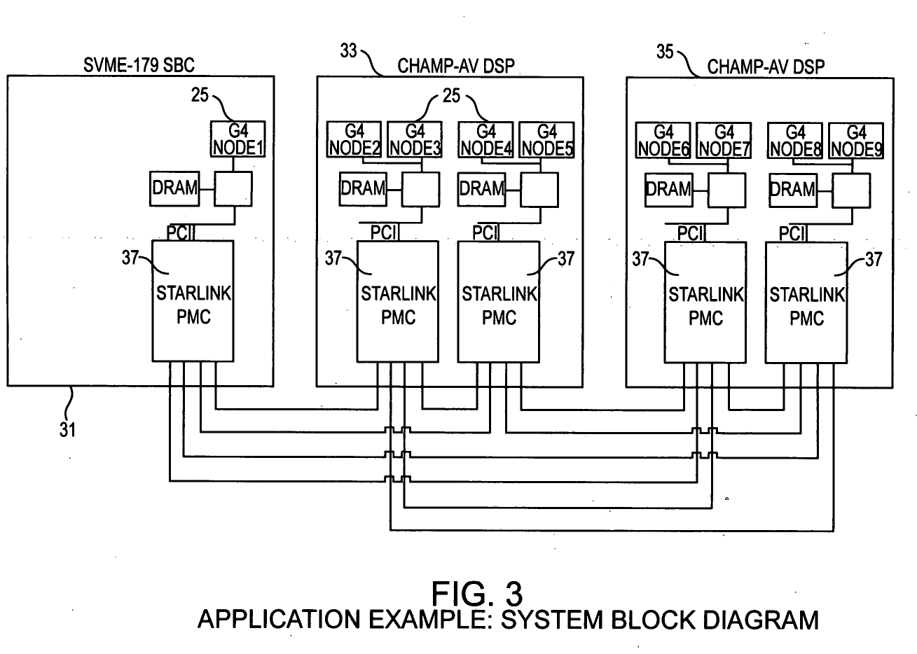

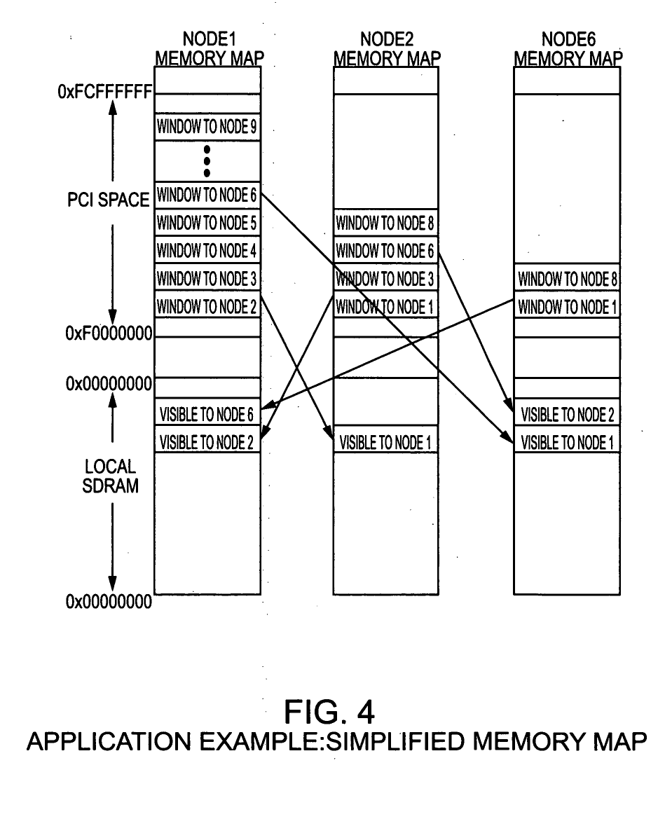

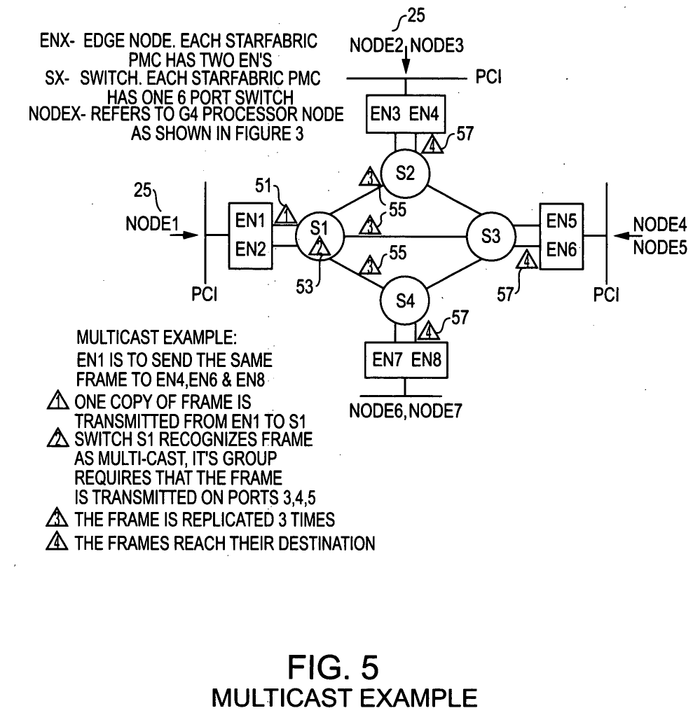

In FIG. 3, Application Example, System Block Diagram, an actual hardware implementation of the network is presented. This example is of a small processing system comprised of a Single Board Computer 31 such as the SVME-179 SBC and two quad PowerPC DSP boards 33 and 35 such as the CHAMP-AV circuit card manufactured by DY4 Systems, FIG. 8. The DSP boards 33 and 35 each carry two PMC's 37. The single processor card 31 carries only a single PMC 37. This configuration provides each DSP with the highest possible I/O bandwidth. In many systems, one PMC will be sufficient to manage the data I/O requirements of the system application. In FIG. 4, three simplified memory maps, one for each of three processors are presented to illustrate how the network presents itself to an application program. One processor from each card is selected for the purpose of illutration.

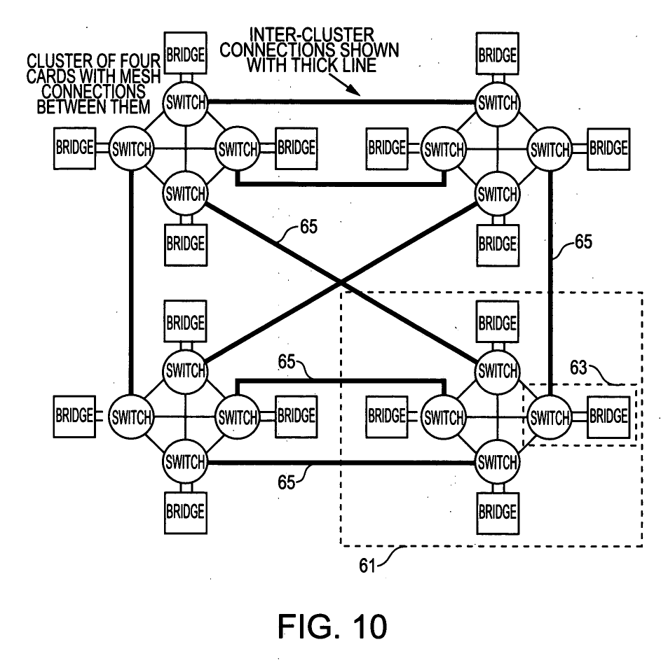

FIG. 7 illustrates an alternative implementation with a Single Board Computer 71 such as the SVME-181 SBC and two quad PowerPC DSP boards 73 and 75 such as the CHAMP-AV II circuit card manufactured by DY4 Systems, FIG. 9. Because of the differences in architecture on the card, the PCI structure may be implemented differently, however the connection established is consistent. FIG. 7 also illustrates teh optional, dashed connections 77 and the minimal required connections 79 for implementation of the fabric network.

In the upper half of each memory map, illustrated in FIG. 4, is the PCI space as seen from the local processor. Within that address range, are blocks that map to physical SDRAM on another card somewhere in the fabric. In this example, Node 1 (on the SBC) has regions which are mapped to all of the other nodes in the system. Up to 1024 nodes may be mapped in this manner. When the Node 1 processor reads or writes into this PCI space, the fabric network routes the data to the appropriate node across the fabric. The simplicity of this from a software perspective is noteworthy. The processor can read and write single memory locations, or for high performance applications, the data can be moved by DMA controllers in large blocks.

In the lower half of the memory map, is the local SDRAM. In each node's local SDRAM, are address ranges where another node in the fabric can read and write this memory. If desired, more than one external node can be mapped to the same address.

A second application example, FIG. 10, illustrates how a system can be scaled to larger configurations using the PMC of the present invention. In FIG. 10, a sixteen board embodiment is illustrated. A network is constructed using four clusters 61, of four PMC boards 63 each. Within each cluster, is a high bandwidth fabric. Each cluster 61 is then also configured to make four connections to other clusters, which in this case are arranged with one connection to the other three, and a two links to one of the three, which depending on the application represent a higher bandwidth requirement, or also a redundant connection existing at a chassis level. As before, any node on the fabric can communicate with any other node. There are also redundant paths for any connection in the fabric, so that the failure of any board, or any external link will not bring down the operation of the rest of the system.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A computer card for data transfer in a network of multiple computer cards, comprising:
a circuit card comprising a PCI bus;
a PCI-based mezzanine card, mounted to the circuit card and connected to the PCI bus for access to processing resources and memory resources of the circuit card;
a multi-port fabric switch; and
a PCI-to-switch fabric bridge comprising a port connected to the fabric switch.

2. A system for networking multiple computer cards for data transfer, comprising:
a plurality of networked circuit cards, each card comprising:
a PCI bus;
a PCI-based mezzanine card, mounted to the circuit card and connected to the PCI bus for access to processing resources and memory resources of the circuit card;
a multi-port fabric switch comprising a port for connecting said mezzanine card to a second mezzanine card in said network; and
a PCI-to-switch fabric bridge comprising a port connected to the fabric switch.
